(19) United States
(12) Patent Application Publication
(10) Pub. No.: US 2007/0063895 A1
(43) Pub. Date: Mar. 22, 2007

(54) LOW FREQUENCY TAG AND SYSTEM

(75) Inventors: Jason AUGUST, Toronto, ON (CA); Paul WATERHOUSE, Selkirk, ON (CA); John K. STEVENS, Stratham, NH (US); Michael J. VANDENBERG, Erin, ON (CA); Kenneth TRUONG, Scarborough, ON (CA)

Correspondence Address: Oppedahl Patent Law Firm LLC - VAI, P.O. BOX 4850, FRISCO, CO, 80443-4850, US

(73) Assignee: VISIBLE ASSETS, INC., Mississauga (CA)

(21) Appl. No.: 11/276,096

(22) Filed: Feb. 14, 2006

Related U.S. Application Data
(60) Provisional application No. 60/652,554, filed on Feb. 14, 2005.
(60) Provisional application No. 60/595,156, filed on Jun. 10, 2005.

(51) Int. Cl. H01Q 3/00

(52) U.S. Cl. 342/359

(57) ABSTRACT

An active two way radio tag (e.g. used for tracking assets, people or livestock) operates below 1 MHz and includes an integrated circuit operable to generate and transmit data signals at a frequency below 1 megahertz, a timing circuit (e.g. a crystal), for controlling the frequency, and a battery or other energy source operable to energize said integrated circuit and said timing circuit. The active tag may further include a data storage device (e.g. a static or dynamic memory) operable to store data identifying the tag.

This application claims priority from U.S. application No. 60/652,554 filed Feb. 14, 2005, which application is hereby incorporated herein by reference for all purposes.

### BACKGROUND

Radio Frequency Identity tags or RFID tags have a long history and have been based largely upon the use of “transponders” tags, each with a fixed pre-programmed ID. These tags are often designed to replace barcodes and are capable of low-power two-way communications (U.S. Pat. No. 3,713,148, The Mercury News, RFID pioneers discuss its origins, Sun, Jul. 18, 2004). Active RFID tags have a battery to power the tag circuitry. They are typically large devices operating in the 13 MHz to 2.3 GHz frequency range and work as transponders. A transponder uses a carrier transmitted by a base station to and the tag usually communicates by simply shorting or detuning a resonant-tuned antenna to produce a change in the reflected energy. This produces a reflected signal that can be detected by a base station. This approach minimizes the complexity of the circuitry contained in the tag. Passive RFID transponder tags do not have a battery and use the same carrier signal for power.

Passive RF-ID tags also have an antenna consisting of a wire coil or an antenna coil etched onto a PC board. Such an antenna coil in a passive tag serves four functions:
1. It serves as an antenna for detecting the carrier radio signals that contains the data signal.
2. It serves as a power source. The tag receives a carrier signal from a base station and uses the carrier signal to provide power to the integrated circuitry and logic on the tag.
3. It may also serve as a frequency and phase reference for radio communications. The tag can use the same coil to receive a carrier at a precise frequency and phase reference for the circuitry within the radio tag for communications back to the reader/writer.
4. It can also serve as a clock used to drive the logic and circuitry within the integrated circuit. In some cases the carrier signal is modulated or divided down to produce a lower clock speed.

It is generally assumed that a passive transponder tag is less costly than an active transponder tag since it has fewer components and is less complex. Thus, many investigators will assume that a passive transponder tag has the potential to eliminate the need and cost for a battery as well as an internal frequency reference standard such as a crystal or compensated oscillator (e.g. U.S. Pat. No. 5,241,286) for precise control of phase and frequency. Changing from a passive transponder to an active transponder tag only eliminates the crystal and requires the extra cost of battery. In addition, since passive transponder tags have precise known phase and frequency since they can use an external common reference (the carrier signal) it is possible to enhance extraction of the tag signal from background noise (U.S. Pat. No. 4,821,291). It is also possible to use this precise reference to provide enhanced anti-collision methods so as to make it possible to read many tags within a carrier field (U.S. Pat. No. 6,297,734, U.S. Pat. No. 6,566,997, U.S. Pat. No. 5,995,019, U.S. Pat. No. 5,591,951). Transponder RFID tags typically operate at several different frequencies within the Part 15 rules of the FCC (Federal Communication Commission) between 10 kHz to 500 kHz (Very Low Frequency, Low Frequency, and Short-Wave), 13.56 MHz (High Frequency or HF) in or 433 MHz and 868/915 MHz or 2.2 GHz (Ultra High Frequency or UHF). The higher frequencies are typically used to provide high bandwidth for communications, on a high-speed conveyor for example, or where many thousands of tags must be read rapidly. In addition, the higher frequencies are more efficient for transmission of signals and require much smaller antennas for optimal transmission. (It may be noted that a self-resonated antenna for 915 MHz can have a diameter as small as 0.5 cm.)

History of Spectrum Movement

In the field of radio tags, as in most other fields that use radio frequencies, there has been a steady movement over the decades from lower frequencies to higher frequencies. Consider, for example, the frequencies that have been in common use in consumer cordless telephones, listed by approximate first year of use:

| Frequency | Year |
|---|---|
| 27 | 1980 |
| 47/49 MHz | 1986 |
| 900 MHz | 1990 |
| 1.2 GHz | 1992 |
| 2.4 GHz | 1998 |
| 5.8 Ghz | 2002 |

Consider, too, the highest frequencies in use for any purpose, listed by approximate decade of first use:

| | | | |
|---|---|---|---|
| 30 kHz to 300 kHz | LF | 1890's | Marconi's spark-gap |
| | | | transmitters |
| 300 kHz to 3 MHz | MF | 1930's | AM radio |
| 3 MHz to 30 MHz | HF | 1930's | shortwave |
| 30 MHz to 300 MHz | VHF | 1940's | FM radio, television channels |
| | | | 2-13 |
| 300 MHz to 3 GHz | UHF | 1950's | Television channels 14-83 |
| 3 GHz to 30 GHz | SHF | 1980's | |
| 30 GHz to 300 GHz | EHF | | |

It may be seen from the above that there has been a steady push away from lower frequencies and toward higher frequencies. This steady push is motivated by many factors, including some signal-to-noise factors discussed below, and it makes the present invention, which represents a push back to much lower frequencies, rather non-intuitive.

The shifting perspective of RF engineers and other decisionmakers who choose which part of the spectrum to use for a particular purpose may be appreciated from the terminology itself. Radio waves in the band 3 MHz to 30 MHz are often called “short wave” precisely because they were much shorter than any waves that were used before those waves were used. They were considered to be at the frontier, waves that had never before been used. Yet now the waves commonly used (30 MHz and above) for nearly all new applications are far, far shorter than “short waves”. Stated differently, what is called “short waves” are waves that are actually much longer than most waves used nowadays for many different applications.

High Frequency Passive RFID Tag Advantages

These higher frequencies RF tags are often used since they have the advantages of longer transmission distance (potentially over 100 feet) within the Part 15 FCC rules. As the transmission frequency goes down below 500 kHz, it is no longer possible to use optimal Electric Field antennas on the tag or from the base station since the wave length is so very long (which requires a large antenna for signal detection). Because of the need for a smaller antenna footprint, HF, VHF and UHF are preferred frequencies for most RFID tags. In addition, optimal antennas at HF, VHF and UHF frequencies require few turns to achieve resonance and may be printed directly onto flexible PC (printed circuit) boards as part of the etched traces on the board itself. Thus, the higher frequencies are thought to be far more efficient for transmission of signals because they require much smaller antennas and therefore eliminates the cost and need for a separate coil or wound antenna. In theory, this reduces production cost, and in some cases size, and makes it possible to produce, passive transponders tags with highly automated equipment, at costs below 30 or 40 cents.

Finally, the higher frequencies also typically provide high speed and high bandwidth for communications. On a high-speed conveyor for example, many thousands of tags attached to individual packages are carried on a pallet moving at 6 mph. This means 200-300 tags must identified and read in under a few seconds. This can only be achieved with a high-bandwidth system with data rates near 1 MHz and a carrier in the 100's of MHz.

One minor disadvantage of a system using HF, VHF and UHF passive tags is that the reader or base station must be more complex (over an active system) and is often more expensive. The reader must transmit a reference signal to power the tag as well as to provide a frequency standard. Often the algorithms used to network tags may require complex circuitry in the base station as well. Finally, as the frequency goes up the cost of the integrated circuits require to read and write to the passive tags in the base station also rises. However, the working assumption is that the reader cost is not a major factor since it can be used over many millions of tags and that the tag cost is far more critical. Any functionality that can be moved to the reader from the tag therefore makes economic sense.

These passive HF, VHF, and UHF tags may therefore be functionally quite simple and contain only an integrated circuit (IC), mounted on an etched flexible circuit board with no other components. No battery, no crystal, and no other components are required, the speed of data transmission can be high, and they can be read at long range at a low cost.

Disadvantages of Present-Day Prior Art Low Frequency (LF) Tags

Passive LF transponder radio tags are in widespread use as RFID tags for pets and livestock and even humans, largely because these frequencies are not effected by water or liquids contained in living animals. (Higher frequencies are more affected by water and liquids because the “skin depth” diminishes with higher frequencies.) Because of many other disadvantages described below, however, LF tags are generally not used for other applications.

The major disadvantage of LF tags is that the detectable radiant energy leaving the transmission antenna is largely a magnetic (M) field rather than an electric (E) field. This magnetic mode of transmission (also called inductive transmission), has the major disadvantage of providing only a short range. The inductive signal drops off as 1/d³ while the electric field signals at higher frequency drops off as 1/d² in the near field and 1/d in far-field conditions, where “d” is distance from a point-source antenna. Thus, the inductive or M radiance mode of transmission will theoretically and in practice severely limit the distance of transmission to only a few inches. In addition LF tags are very slow because the carrier frequency (e.g. 100 kHz to 200 kHz) is low compared to HF, VHF and UHF.

Since transmission is inductive the tag requires a separate, many-turn, wound wire antenna in place of the etched circuit board antenna. Thus, in general it is often assumed that LF radio tags will be more expensive since they do require a wound-wire antenna. However, it is possible to make a low-cost LF passive tag with an antenna coil and chip and no PC board (WO03094106A1). There are many other disadvantages with current commercial LF tags.

Because of these many disadvantages of LF, the RFID frequencies now recommended by many commercial (Item-Level Visibility In the Pharmaceutical Supply Chain: A Comparison of HF, UHF RFID Technologies, July 2004, Texas Instruments, Phillips Semiconductors, and TagSys Inc.), government organizations (see Radio Frequency Identification Feasibility Studies and Pilot, FDA Compliance Policy HFC-230, Sec 400.210, November, 2004, recommend use of LF, HF or UHF) as well as standards associations (EPCglobal, web page tag specifications, January 2005, note LF is excluded) do not mention or discuss the use of LF as an option in many important applications. Many of the commercial organizations recommending these higher frequencies believe that passive and or active radio tags in these low frequencies are not suitable for any of these applications for reasons given above.

Many commercial companies actually manufacture LF radio tags (e.g. Both Texas Instruments and Philips Semiconductor. See Item-Level Visibility In the Pharmaceutical Supply Chain: A Comparison of HF, UHF RFID Technologies, July 2004, Texas Instruments, Phillips Semiconductors, and TagSys Inc.) yet recommend the use of 13.56 MHz or higher again because of the many disadvantage of LF outlined above, and the many advantages of HF, VHF and UHF.

A detailed summary of the reasons that current LF radio tags have not generally been considered for use in many applications is summarized below.
1. LF is believed to have very short range since it uses largely inductive or magnetic radiance that drops off as 1/d³ while far-field HF. VHF and UHF drops off as 1/d, where d is distance from the source. Thus, the inductive or magnetic radiance mode of transmission will theoretically limit the distance of transmission, and that has been one of the major justifications for use of HF and UHF passive radio tags in many applications.
2. The transmission speed is inherently slow using LF as compared to HF, VHF and UHF since the tag must communicate with low baud rates because of the low transmission carrier frequency.
3. Many sources of noise exist at these LF frequencies from electronic devices, motors, florescent ballasts, computer systems, power cables. Thus LF is often thought to be inherently more susceptible to noise.
4. Radio tags in this frequency range are thought to be more expensive since they require a wound coil antenna because of the requirement for many turns to achieve optimal electrical properties (maximum Q). In contrast HF, VHF and UHF tags can use antennas etched directly on a printed circuit board and LF would have even more serious distance limitations with such an antenna.
5. Current networking methods used by high frequency tags, as used in HF, VHF and UHF, are impractical due to such low bandwidth of LF tags described above in point 3 immediately above.

Active high frequency radio tags overcome many of these objections, especially the transmission distance issue, and in many cases they can be designed to function in harsh environments using advanced communication algorithms (e.g. Spread-spectrum), the memory speed issues may be addressed using high speed static memory, and finally these active tags may use. However active LF, HF, VHF and UHF tags have two major disadvantages: First, since the power consumption of any solid state circuit is proportional to the operating speed, active LF, HF, VHF and UHF tags require large batteries with limited life (two to maximum five years) and as a result are bulky heavy devices; Second, they must use high speed semiconductor devices that have a major impact on the active tag costs as compared to other semiconductor processes that operate at lower frequencies. Since these high-speed semiconductor devices require many more fabrication steps over lower-cost commodity processes such as static metal gate CMOS (8 steps vs maybe 22 steps) for a silicon wafer. These cost disadvantages of LF, HF, VHF and UHF active tags are fundamental and will always be an issue.

### High Frequency, Very High Frequency, and Ultra High Frequency Limitations in Certain Applications

Many unexpected functional disadvantages have recently been discovered with actual widespread use of passive radio HF, VHF and UHF tags in the field (“Radio tags are falling off the fast track”, The Boston Globe, Scott Kirsner, May 31, 2004; “Despite Wal-Mart's Edict, Radio Tags Will Take Time”, The New York Times, Barnaby Feder, Dec. 28, 2004).
1. HF, VHF and UHF transponders tags transmit with limited power since they can obtain power only from a rectified carrier signal. In some tags this power requirement may limit the transmission range to only a few inches or at most to a few feet. This is especially true with 13.56 Mhz.
2. HF, VHF and UHF transponder tags are highly angle sensitive. If tag is twisted by 20-30 degrees from parallel to the plane of the antenna, the signal may drop enough to lead to a read failure. This is due to the limited dynamic range of the amplifier used in these tags since it is powered by the antenna coil. In other words it is possible to build an amplifier to read the reduced data signal over a wide dynamic range seen as the tag rotates, but nothing can be done when the power for the amplifier drops out because of the angle. When the power drops below a critical level as the tag rotates, the chip and logic will simply stop functioning below this critical level.
3. Transponder HF, VHF and UHF tags do not work well around metal or liquids. This is part due to limited transmission power, but also in part due to fact that higher frequency radio signals reflect or are blocked by any conductive surface or material, and high frequencies are absorbed and as a result effectively blocked by liquids. In many cases the read errors rates in a warehouse are as high as 40% (“Radio tags are falling off the fast track”, The Boston Globe, Scott Kirsner, May 31, 2004).
4. Current anti-collision systems (U.S. Pat. No. 6,297,734, U.S. Pat. No. 6,566,997, U.S. Pat. No. 5,995,019, U.S. Pat. No. 5,591,951) used to read or “discover” many tags within a field limit the total number of tags that can be read at any time. In practice only 25-50 tags can be read within a carrier field.
5. Transponder tags often have a preprogrammed fixed ID, created at the time the tag is manufactured. This requires an external database and “lookup” function to discover the identity of the radio tag and to obtain information about the product or item that has been tagged. The direct cost associated with this database is often difficult to predict in advance of any use and often requires additional expensive hardware such as a wireless handheld computer to identify an item in the field.
6. Many applications require that data be written and stored in the tag after the tag is applied and and also require that the tag be quickly read in the field without a database lookup. This requirement forces any passive transponder tag to use Electrical Erasable Programmable Read Only Memory (EEPROM) or similar storage system since it does not have a battery to maintain power for conventional Dynamic (DRAM) or Static (SRAM) memory. For example, the FDA recommends that all data be written to the tag after it is affixed to a container so that it cannot be accidentally confused with another container (see Radio Frequency Identification Feasibility Studies and Pilot, FDA Compliance Policy HFC-230, Sec 400.210, November, 2004, 4. “Writing to a tag before it is affixed to a container increases the risk of product mix-ups. We suggest that industry and other interested parties explore the feasibility of writing to the tag after it is affixed to the container.”). This memory requirement in passive tags has several unexpected disadvantages.
   The cost of EEPROM significantly raises the cost of the passive transponder tags since it involves many extra processing steps in the production of the integrated circuit. It may be as high as 22 steps compared to 14 for silicon gate CMOS. Since the cost of an integrated circuit is tied directly to number of processing steps, this may have dramatic cost implications. In addition, the cost of EEPROM as compared with conventional Random Access Memory (RAM) is significant since EEPROM also requires about 60% larger area on the integrated circuit over RAM. Fabrication cost for an integrated circuit is directly related to its area.
   EEPROM significantly slows down the read and write process in some cases over 1000 times however, as compared with what could be archived with conventional static memory. Communication speed with a passive tag HF, VHF or UHF that has a read/write memory requirement may be significantly reduced. As a result most applications using passive HF, VHF and UHF tags use a large fixed ID that must be programed as described under point 5, above, and this leads to significant increased IT costs.
   The erasing of EEPROM requires significant power as compared with conventional SRAM and this additional power requirement may also reduce read distance and increase angle sensitivity especially if there are many reads and writes to memory.
   In practice because of the increased size of the chip, speed, and power requirements, passive RF chips are limited to about 2,048 bits or 256 bytes of memory. In many applications where data may have to be logged repeatedly over long period of time (temperature for example) this storage size is not sufficient.
7. In many cases, especially in health care applications, it may also be important to monitor the temperature or humidity of the product, and this cannot be carried out without some source of power. A typical monitoring device without an active clock and time of day independent of the carrier, typically cannot record temperature either as a histogram or data log.
8. In many cases a light emitting diode (LED) as part of the tag could be used to identify selected items to be removed from an area or to be placed on a shelf. However, this additional power requirement of an LED would lead to significant reduction in range and an increased angle sensitivity of the tag.
9. The HF and UHF passive tags often must be read with a handheld computer brought within close reading distance to the tag. For example, a wrist band used for patients in a hospital may have many arbitrary positions and angles. It is difficult to place a reader on a wall and guarantee that it is able to capture data as the patient passes by. Therefore, a nurse or other professional may be required to take a handheld computer to read the tag to identify the patient as well as to document the patient's location at that time. This new additional manual step often leads to unreliability within any inventory management system or tracking system.
10. The handheld device required to read a HF, VHF or UHF tag may be quite expensive for several reasons. For one thing, the read/write circuitry is required to be complex to make the radio tag low cost and simple. In addition, since many tags must use a fixed ID that is an arbitrary number the handheld reader must “look up” the ID in a database. This may require that the handheld reader is equipped with a longer-range RF link to a computer where the “lookups” are performed, further adding to the cost.
11. The passive HF, VHF and UHF tags were thought to help prevent counterfeit products. However, since the tag has no memory or limited memory and no clock to keep track of date and time, it is difficult to provide any public key or encryption protocols that could provide reasonable security systems as a proof of identity or proof of the tags data content.
12. The passive HF, VHF and UHF tags require antennas that have reduced size flexibility. After the antenna reaches a certain frequency-dependent size limit, the gain of the antenna is reduced and it cannot be tuned.

Thus, many unexpected complex issues have appeared as passive RFID tags have been put into widespread use. While many of the current passive transponder tags can be used in applications that do not require significant memory and do require high speed, many of the existing commercial passive transponder tags cannot be used reliably in applications that might make use of steel or metal shelves, on liquid products, or in applications that must read near or in living animals or humans (e.g. livestock identification) especially on injectable or liquid pharmaceuticals, or on medical devices such as DES stents, boxes of sutures, or orthopedic joints where sealed aluminum pouches are often used to hold the sterile device, and wrist bands used to track patents in hospitals. Similar technical problems are encountered when blood plasma is tracked in one-liter bags, with livestock, cattle, pigs and the like and other that must be tracked to establish a health pedigree prior to slaughter, with steel replacement parts and tools used for aircraft maintenance, with systems that track tools during maintenance, and with toxic wastes contained in steel 55-gallon drums, when tracking airline baggage that may contain steel or metal and liquids; all such readings have proven to be unreliable with passive radio transponder tags.

Finally, passive transponder tags have not been successful in providing real-time inventory or automated visibility for products in harsh environments or near steel shelves because of the issues raised above and the limited ability to read many tags within a carrier field in such harsh environments. These problems occur for:
1. Steel or metal shelf, applications that require real time inventory in harsh environment on a shelf.
2. Liquids especially in healthcare applications with injectable drugs.
3. Livestock visibility systems, especially in areas where many cattle must be identified one by one.
4. Applications that require data to be written to the tag, again especially in healthcare where many details linked to expiry date, serial numbers and lot numbers must be written to the tag after it is applied to a particle item of the product.
5. Applications that require sensors or data logs.
6. Applications that may require date and time stamps or digital signatures or proof of content to prevent counterfeiting.
7. Applications that require tags to be read over large areas with long ranges. Passive tags work well “on-axis” but require many transmitters to read a large area.

### SUMMARY OF THE INVENTION

1. Broadly, the present invention provides an active two way radio tag (e.g. used for tracking assets, people or livestock) that operates below 1 MHz and includes
   an integrated circuit operable to generate and transmit data signals at a frequency below 1 megahertz
   a timing circuit (e.g. a crystal), for controlling said frequency,
   a battery or other energy source operable to energize said integrated circuit and said timing circuit.
2. Moreover, the above novel active tag may further comprise a data storage device (e.g. a static or dynamic memory) operable to store data identifying said tag.
3. The invention also provides a system for tracking objects comprising the above active tag and a tag reader (e.g. base station) that comprises a loop field antenna that covers an area of at least 1 square meter.
4. The novel system may be used for tracking assets or people or livestock comprising a passive or active radio tag below 1 MHz and a tag reader that comprises a loop antenna.
5. The invention also provides a loop antenna for transmission below 1 MHz that also provides audio signals compatible with t-coils in hearing aids by modulation of the carrier in the audio frequency range.
6. An above active tag may further operate with a random phase which can be used for identifying the ID of a tag. This can be effected by use of an independent crystal.

### BRIEF DESCRIPTION OF THE FIGURES

FIG. 1 is a schematic block diagram of an LF (Low Frequency) active low frequency tag in accordance with the present invention.

FIG. 2 is a block diagram of a more complex radio tag.

FIG. 3 shows a typical application for a tags, namely in connection with specialty pharmaceuticals with an injectable vial and a tag placed on the cap.

FIG. 4 shows an alternative location for placing the tag, namely on the bottom of the vial.

FIG. 5 shows signal strength as a function of distance for a typical proximity antenna using a passive transponder tag.

FIG. 6 compares cost and data-write times for various types of tags.

FIG. 7 shows in plan view an area loop antenna with tags in its field that can be discovered by use of a reader.

FIG. 8 shows inductive or magnetic field strength as a function of distance for various sizes of field loop antennas.

FIG. 9 shows signal strength as a function of distance for one tag.

FIG. 10 shows signal strength as a function of distance for a tag with a loop antenna, showing a large read area.

FIG. 11 shows signal strength as a function of distance for a smart containment vessel with an RF handheld.

FIG. 12 shows tunability of area inductive antennas as a function of their size.

FIG. 13 shows exemplary shapes of area loops.

FIG. 14 illustrates the random phase which permits read a single tag's ID even though many tags may respond.

FIG. 15 illustrates the use of random phase and different amplitudes to read a tag from among multiple tags.

FIG. 16 shows tag IDs with checksums.

FIG. 17 shows a flowchart for discovery of an ID (using checksums for validation of tag IDs).

### DETAILED DESCRIPTION OF THE INVENTION

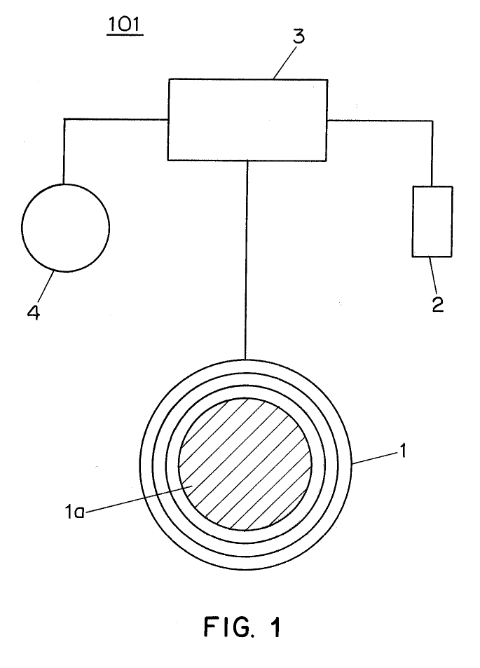

FIG. 1 is a schematic block diagram of an LF (Low Frequency) active low frequency tag 101 in accordance with the present invention. A battery 4 can be a lithium or alkaline battery, (LR44) and may cost as low as 5.5 cents. A CMOS integrated circuit 3 in an exemplary embodiment will contain SRAM. Crystal 2 used for timing. In the exemplary embodiment, crystal 2 is a low-cost 32 kHz watch crystal that is multiplexed 4×. This may optionally be replaced with an oscillator designed as part of the CMOS chip circuitry. An antenna 1 can be wirewound around a ferrite 1a or be an open-loop antenna. The loop radius may be as small as a few mm, or may be 12 inches or larger depending upon the application.

When RF engineers use labels to define portions of the radio spectrum, they usually use “LF” to denote frequencies in the range of 30 kHz to 300 kHz. This is to distinguish between adjacent defined portions such as VLF (usually termed 3 kHz to 30 kHz) and MF (usually termed 300 kHz to 3 MHz). In the context of the present discussion of the invention, however, it frequently arises that it is necessary to speak collectively of a rather wider band, namely frequencies below 1 MHz. For brevity of discussion, therefore, we will use the term LF as a shorthand for “frequencies below 1 MHz.” In this shorthand, “LF” thus creeps some distance into the band usually called MF.

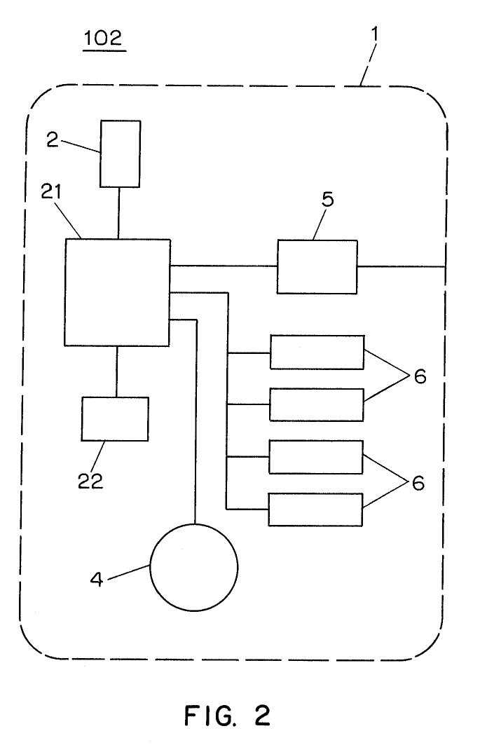

FIG. 2 is a block diagram of a more complex radio tag 102. In this example a low-cost 4-bit microprocessor 21 is used so that the tag can be programmed. The processor 21 may connect to the RF radio modem 5. Separate SRAM 22 may be employed. In addition detectors 6 for humidity, angle, temperature and jog can be added. LEDS (not shown) and displays may also optionally be added. Antenna 1, battery 4, and watch crystal 2 may be seen, much as in FIG. 1.

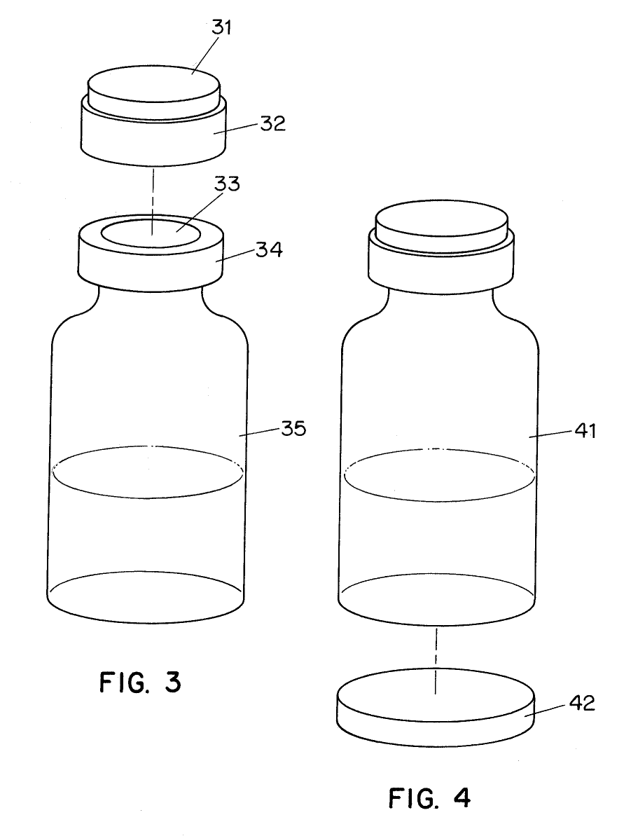

FIG. 3 shows a typical application for tags according to the invention, namely with specialty pharmaceuticals having an injectable vial 35 and a tag 31 placed on the cap 32. In this case, the vial, about 15 mm in diameter, contains liquid that will interfere with UHF, and have UHF-interfering metal in the crimped cap 32 and 34. Other HF tags would likewise not work reliably because of the metal. Moreover the FDA has recommended that these tags store information about the product (serial number, lot number expiry date) after the tag 31 has been placed on the vial 35. Thus the tag requires memory and must work near metal and liquids.

FIG. 4 shows an alternative location for placing the tag 42, namely on the bottom of the vial 41. In some cases an HF tag might function, however the antenna dimensions would be small (about 15 mm in diameter) and would be very short range. UHF would also not work in this configuration because of the liquid in contact with the bottom of the vial. The tag disclosed herein, with a wire coil and ferrite, can function from a distance of many feet and in any orientation in this configuration of FIG. 4 and in the configuration shown in FIG. 3.

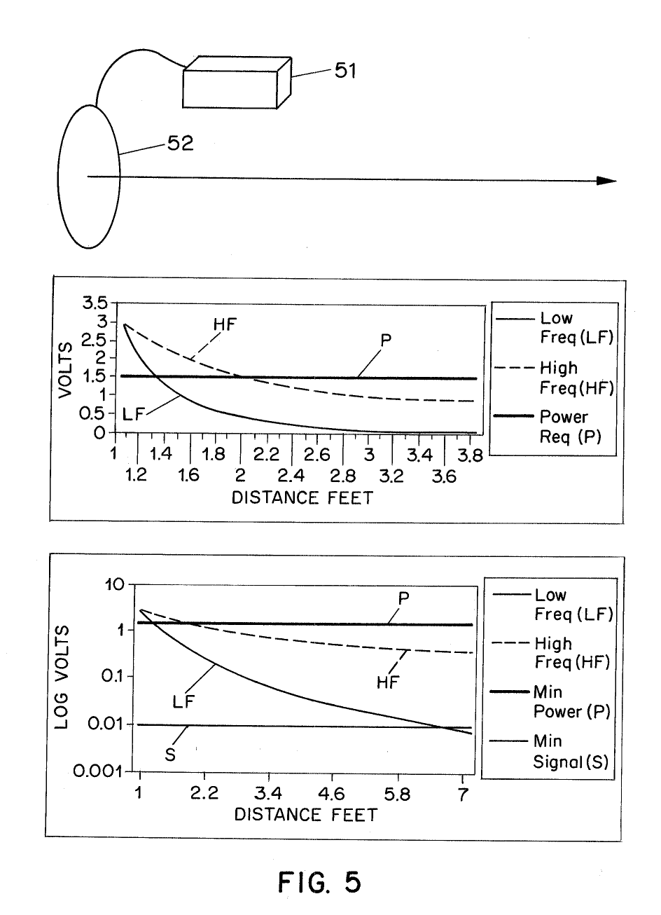

FIG. 5 shows a typical proximity antenna 52 using a passive transponder tag 51. What is shown is the expected signal as a function of distance from the antenna 52. In the upper graph what is shown is the minimum power P required to keep the logic on the integrated circuit functioning. The upper line HF on the graph is the expected needed signal strength for an electric field signal at high frequency (or UHF) as a function of distance. It drops off as 1/d². The lower line is the expected needed signal for a magnetic field at LF. This drops off as 1/d³.

The lower graph is a similar plot on a log scale and with a different horizontal scale. It shows the minimum signal S that can be read using a simple amplifier with wide dynamic range and an ability to read signals over four decades (10 mV to 10 V). As may be seen, a read range of 7 feet is achieved using magnetic signal, as opposed to a passive tag and high frequency HF that can transmit only two feet because it loses power at that point. Stated differently, the intersection of the LF and S lines is far to the right as compared with the intersection of the HF and P lines.

It would be possible to construct an active tag with a battery at these higher frequencies, however because the logic must operate at high frequencies the power consumption is high and the battery life is quite short. Thus an active tag with a battery at low frequencies can have a much longer range and also have long battery life (10-15 years) providing it has a wide-dynamic-range amplifier. This also provides the tag with some immunity from loss of function as the coil is rotated at an angle from the field.

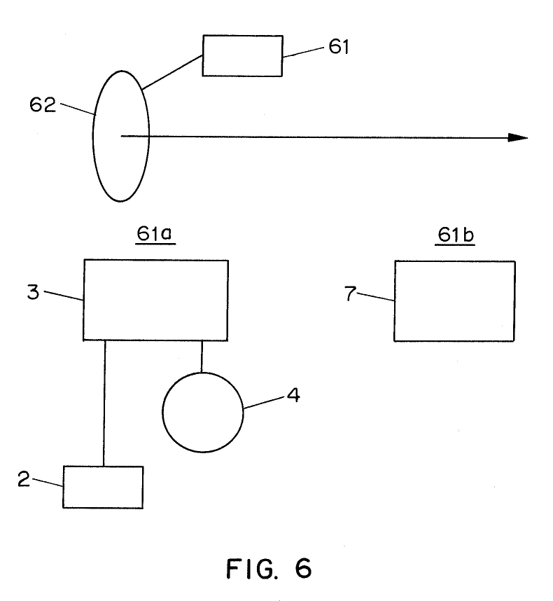

Turning now to FIG. 6, many passive RFID tags 61b have a requirement to store data in the tag. In all cases they must use EEPROM 7 since they have no battery to power SRAM or DRAM 3. An EEPROM requires many extra steps in the processing of its chip wafer and also increases the area of the chip itself by about 60% over what would be required by SRAM. Thus the use of EEPROM raises the cost of a chip in a passive RFID tag. An LF frequency active tag 61a operates at a much lower frequency and as a result may use metal gate CMOS or optionally silicon gate CMOS 3. This has the advantage of low power consumption and low fabrication cost of the chip. In most cases the cost of the battery 4 (6 cents), and a crystal 2 (4 cents) and CMOS chip 3 (5-10 cents) is less than a EEPROM chip 7 with a mere 24 bytes of memory. The result may be an active tag 61a costing only 15-18 cents as compared with a typical 23-50 cents for the passive tag 61b.

In addition the write speed with an EEPROM device 7 is very slow compared to SRAM 3. The communication speed of the LF active tag is slow (1200 to 4800 baud), however the write time of EEPROM 7 makes it possible for the LF tag nonetheless to operate faster and to have a lower materials cost as compared with a tag using EEPROM. Thus, as shown in FIG. 6, a low frequency active tag 61a with antenna 62, may, in fact, have better speed performance at a lower cost when memory is required for storage of any data, as compared with a prior-art passive tag. The read/write time for the SRAM may be must ten cycles or more per second, whereas the corresponding time for the EEPROM may be only one cycle per second.

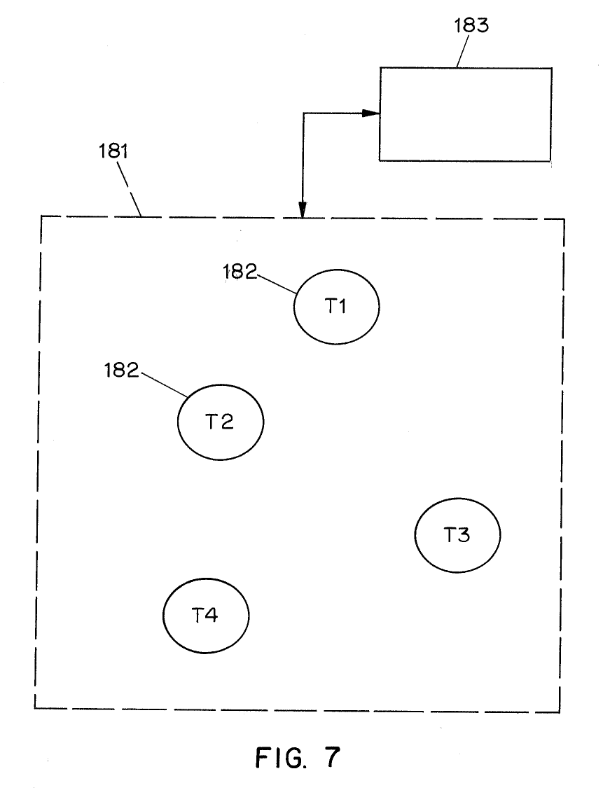

FIG. 7 shows an area loop antenna 181 with tags 182 in its field that can be discovered by use of a reader 183.

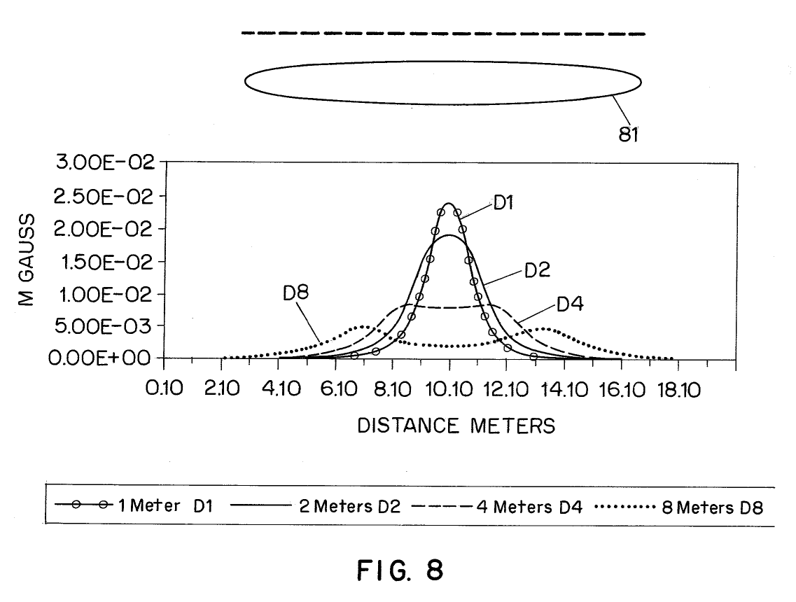

Turning now to FIG. 8, in most cases the base station or reader antenna signal strength is measured axially from the center of the antenna. When inductive or magnetic fields are measured one meter from the antenna with a constant voltage at 100 Khz (1 volt) placed on the loop antenna 81, the strength of the signal decreases as the antenna diameter increases. This graph is the output at 100 kHz for a readily available simulation program (MOMAC) for a 1-meter, 2-meter, 4-meter, and 8-meter field loop.

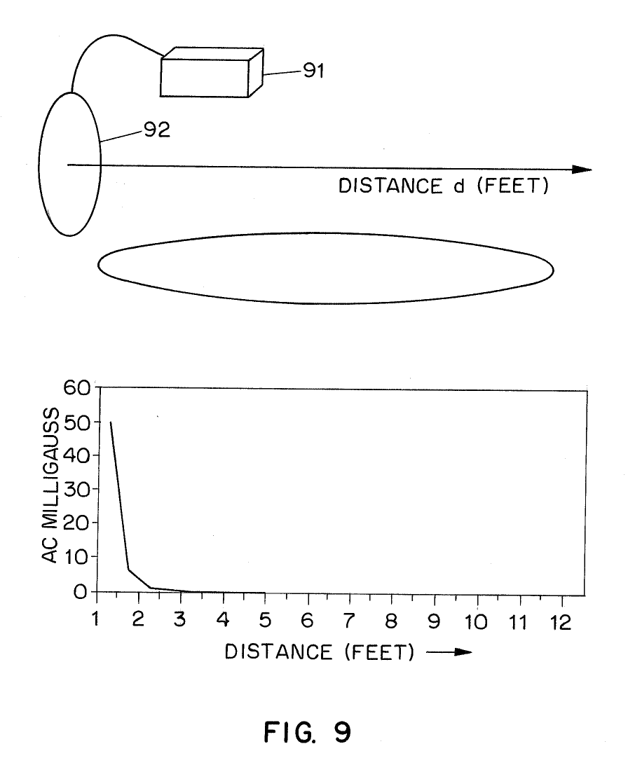

Turning to FIG. 9, when the signal strength is measured as a function of distance it drop off along the axis of an antenna 92 as 1/d³. The graph in FIG. 9 is based on actual measurements using a tuned 1-meter coil antenna at 132 kHz. An active RF tag 91 may function out to five feet where the signal is above 10 mV.

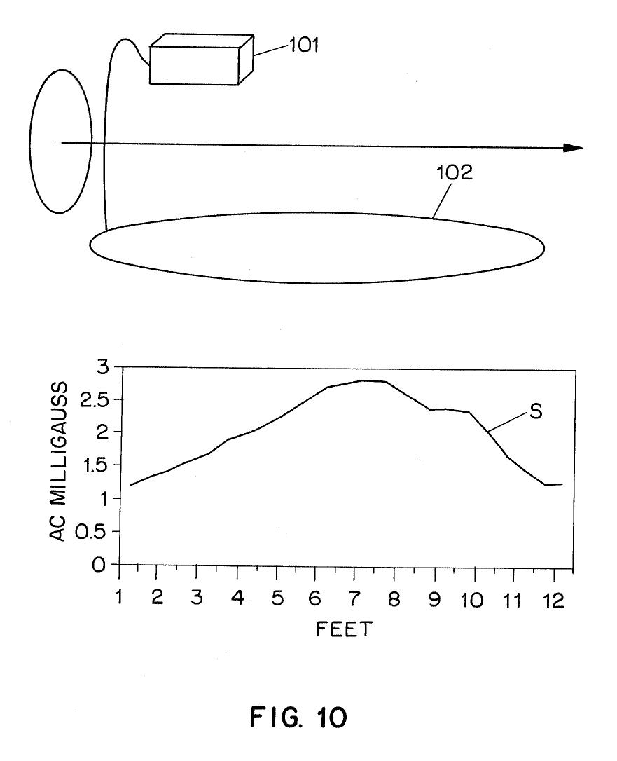

Turning now to FIG. 10, an omni-directional loop antenna 102, placed horizontally on the floor and having a radius of 8 feet, produces a strong signal S (shown in the graph) over that entire area. A tag 101 may be read anywhere within the area of the loop, and in addition may be read outside of the loop, at the same distance found for FIG. 9. In other words the reading area has a diameter of about 18 feet.

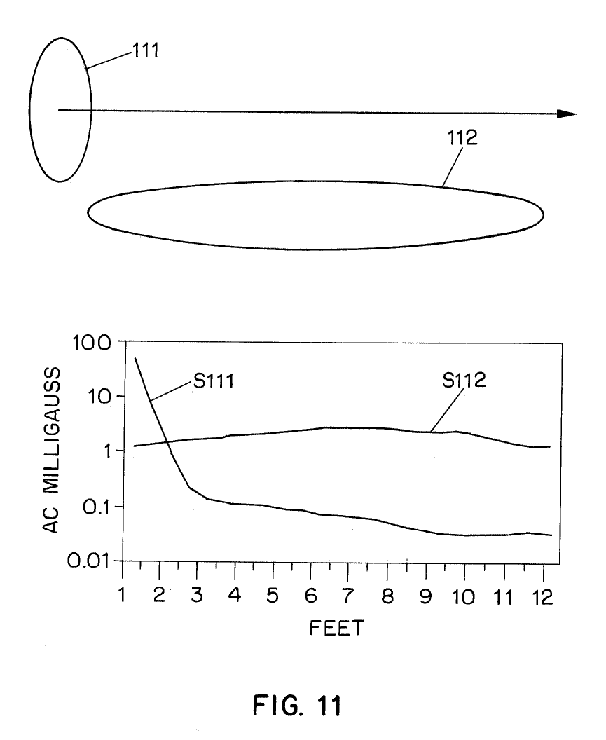

Turning now to FIG. 11, what is shown is a log comparison of an on-axis signal S111 detected by a 1-meter loop signal 111 and a signal S112 detected by a 9-foot floor area loop antenna 112. A tag may be read anywhere within the area of the floor loop 112 plus about five feet beyond the edge thereof.

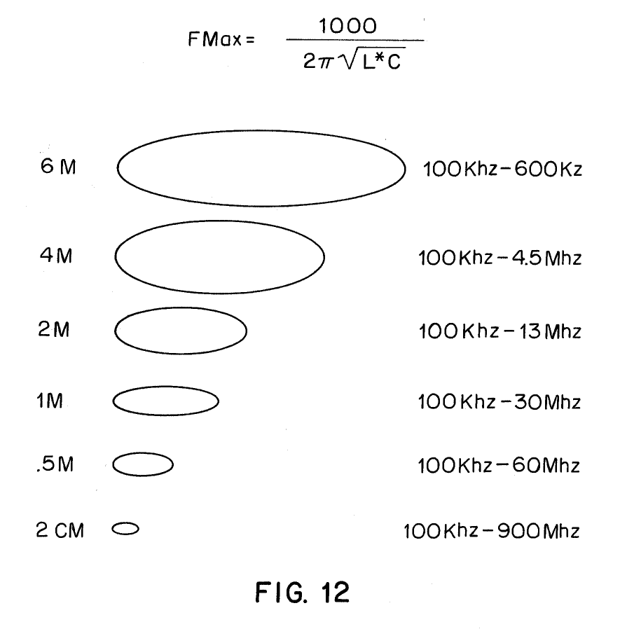

FIG. 12 characterizes the ability to tune loops as a function of their size. The area or size of a loop than can be tuned is limited by the intrinsic capacitance C and inductance L of a loop antenna. As the loop becomes larger these two values go up and the maximum tunable frequency goes down for a magnetic field. The advantage of using the magnetic field over electric field for communication is that the magnetic field is relatively immune to steel and liquids. The electric field, in contrast, can be absorbed by liquids and reflected or blocked by any conductive metal. The distance transmitted using a loop antenna is totally dependent upon the size of the loop, and the size of the loop is inversely related to the maximum tunable frequency. Thus, much longer transmission distance may be obtained with lower frequencies when using the magnetic field as contrasted to the electrical field.

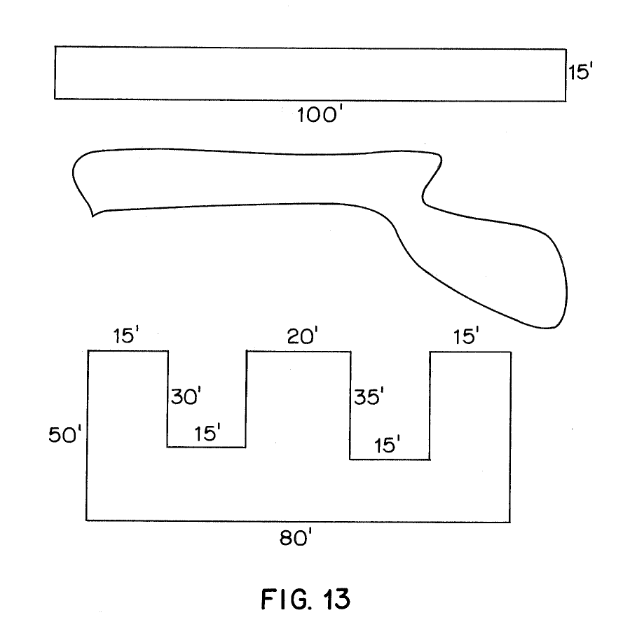

FIG. 13 shows exemplary loop antennas used for area reads. As a practical limit the field loops for LF can be up to 150×150 feet in area and may, as shown in FIG. 13, be placed in almost any shape to maximize the field with that area. When large areas must be covered it is possible to create an array of overlapping loops hooked up to separate base stations or multiplexed by a single base station. The ability of the antenna to assume almost any shape means that its perimeter can define concavities reducing the area of the antenna by ten percent or twenty percent, or for example by the amounts illustrated in the figure.

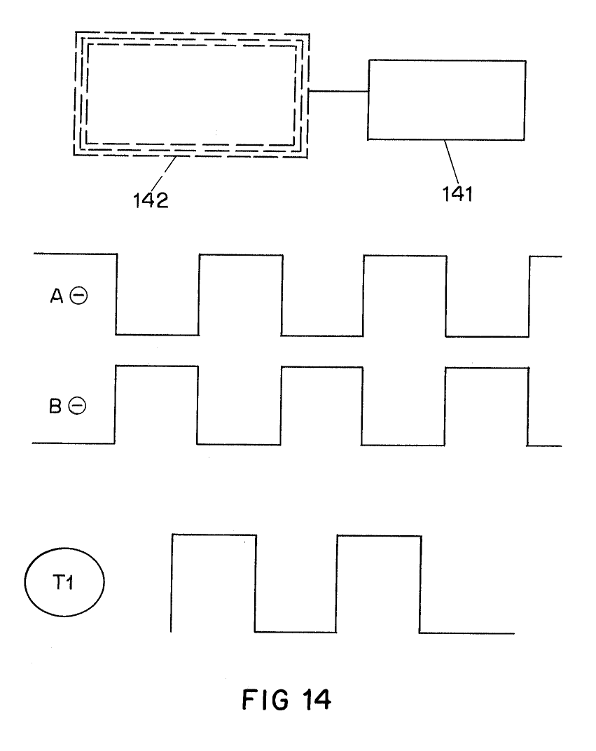

Turning now to FIG. 14, one of the unexpected advantages of the crystal in an active LF tag is that it provides a random phase for each tag T1 making it possible to read a single tag's ID even though many tags may respond. The base station has filters that operate at two phases shifted from each other by 180 degrees, and each phase has its own amplifier. Tags transmit to the A channel and B channel at the same time and the base station 141 simply selects the phase channel that provides the greatest amplitude. The base station 141 employs antenna 142.

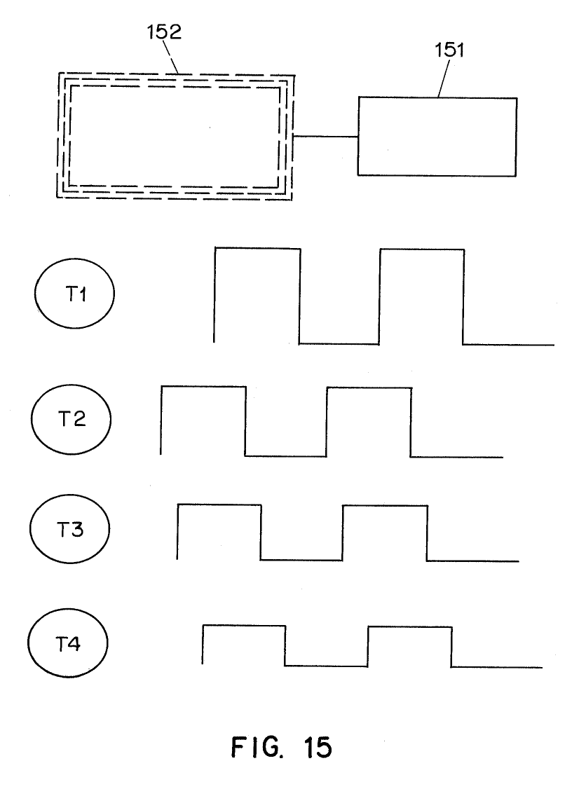

Turning now to FIG. 15, in a field with many tags T1, T2, T3, and T4, all with different phases and at different amplitudes, because they are at different distances one tag will “win” and the ID can be read correctly. This tag is addressed using the discovered ID and is then “turned off” for some prearranged interval of time. Then the next group of tags is interrogated, and so on, until all IDs are discovered. This works efficiently for a field of 50-100 tags. Reader/writer 151 is shown employing antenna 152.

The teachings in FIGS. 14 and 15 may be described in different words. In FIGS. 14 and 15 what must be appreciated is that with a prior-art passive tag, it gets its phase from the stimulating field. Thus if an area contains many tags, they all have exactly the same phase and thus all respond in a way that almost assures that each will interfere with the other and that no particular tag will be any easier to read than its neighbors.

In contrast, with the tags according to the invention, each having its own free-running time reference, it will commonly happen that one will be more readable than its neighbors and thus can be read and “turned off” for a period of time, thus enabling the reading of one of its neighbors. Such a tag has a time reference that is internal to the tag, and that is independent of any RF carrier or signal received from external to the tag.

Traditional methods of “antenna diversity” are not required to achieve the results shown in FIGS. 14 and 15.

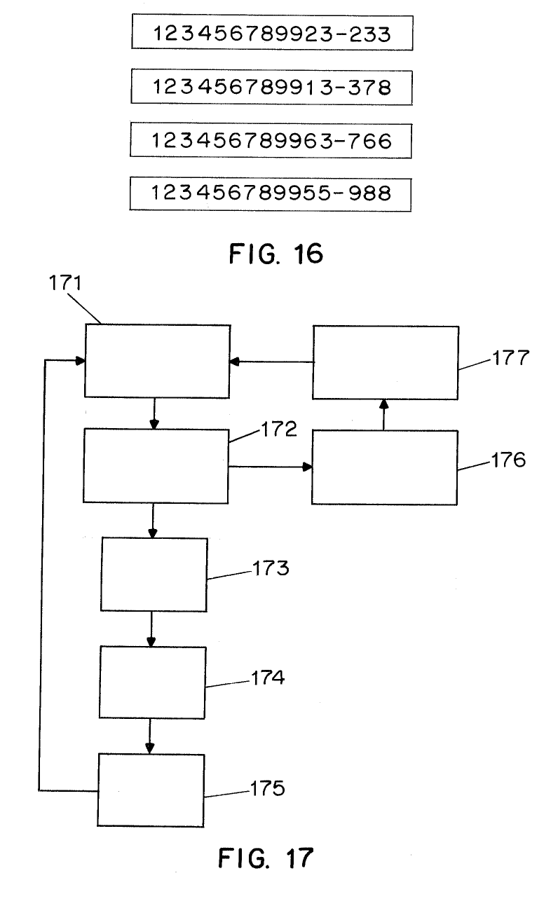

FIG. 16 shows tag IDs with checksums.

FIG. 17 shows a flow chart for discovery of an ID (using checksums for validation of tag IDs).

Some overview may be helpful. What has been developed is an integrated “visibility system” that overcomes many of the objections described above for LF systems and overcomes many of the problems outlined for HF, VHF and UHF in many applications. The visibility system tag has the capability of high memory capacity (8 kilobytes), full data logs, temperature monitoring, optional LEDs, and LCD displays. These tags do not use the transponder method of communications and actually transmit a signal through a tuned antenna using induction. Because the tags work at relatively low frequencies they do not require much power and have a battery life of 10 to 15 years using a 300 mAH lithium battery. They may store data that might normally be contained in a database, can be read anywhere within an open area up to 150 feet by 150 feet or a defined area of 15 feet by 500 feet. LF tags with the present system have been successfully read at distances of over 500 feet. In the exemplary embodiment the LF tags can write stored data in some cases at higher speeds than current HF and UHF tags.

The system uses a low-cost active LF radio tag, a novel antenna design optimized for long-range area reads and inductive communication for tracking products, and providing real-time visibility of products, especially products that require provide real-time inventory of products, and real-time status of products in harsh environments. The tags may be small and often have a lower direct cost than passive RF tags, and can reduce systems cost by eliminating much of the IT software required for passive tags.

The tags may be used for livestock identity and pedigrees, for identity of humans in a building or in an area, for tracking medical devices, or used for tracking pharmaceuticals.

Examples of uses of the tags include:
1. Real-time visibility systems for medical devices and pharmaceuticals, on shelves in hospitals.
2. Real-time visibility systems for medical devices and pharmaceuticals as they are distributed throughout the supply chain, including in trucks and in warehouses.
3. Real-time visibility systems for livestock. This radio tag may optionally have active storage memory, overcomes many of the range, angle and costs issues outlined above as well as networking issues. This tag transmission is in the LF range and is in compliance with FCC Part 15 regulations between 8 kHz and 500 kHz. In an exemplary embodiment, the active LF tag transmits and receives using a frequency of 128 kHz.
4. Real-time visibility system in hospitals for patients, nurses and physicians. Each patient may be provided with an active wrist band that can be read within an area. Data about the patient may be stored in the wrist tag. Similar systems may be created for physician using an ID tag.

The LF tag system's unique features are:
1. A battery (or other energy storage device or other energy source) to power the logic, memory and other circuitry as well as to enhance the power of the transmission to and from a reader. The battery also serves as power for optional detectors and sensors, as well as LCDs and LEDs.
2. A crystal to provide a carrier-independent, host-independent frequency reference. In an exemplary embodiment a 32-kHz crystal is used of the type that is commonly used in watches or devices that require a timing standard. This is used as a frequency reference for transmission, date and time. The crystal serves as a timing reference or clock for recording date and time. This makes it possible for the tag to create logs and records of temperature humidity and other parameters. It also provides for a dynamic proof of content that can be changed every period of time. The crystal also provides for the ability for the tag to become an “on-demand” client to transmit when a specific condition is met or an optional sensor value is exceeded without the need of a reference carrier. The crystal frequency may be multiplied 4 times to achieve a transmission frequency of 128 kHz.
3. The crystal also provides for random (or perhaps more precisely, non-correlated) phase between each module. Passive and other active tags all use a transponder mode and use carrier frequency as a reference. The crystal is viewed as unnecessary in other tags and is eliminated to save cost and space. However, the crystal unexpectedly provides for the ability to selectively read one tag within an area, without prior knowledge of its ID. This random phase and “network discovery” is enabled by the use of the crystal, as opposed to anti-collision and antenna-diversity methods used in other radio tags.
4. Low-power logic, and communications circuitry (a radio modem) that makes use of standard complementary metal oxide semiconductor or CMOS. CMOS is a widely used type of semiconductor. CMOS semiconductors use both NMOS (negative polarity) and PMOS (positive polarity) circuits. Since only one of the circuit types is on at any given time, CMOS chips require less power than other chips. The power consumption of static CMOS logic is directly proportional to switching frequency. HF, VHF and UHF tags can use batteries to enhance power but because of the higher speeds required, and typical need for high bandwidth, the battery life is limited.
5. Memory or storage means attached or contained in the circuitry described under point 3 immediately above using static or dynamic storage systems also based on CMOS designs and powered by battery under “1” with timing and logic functions based on the crystal, described under point 2 immediately above.
6. A wide-dynamic-range amplifier on the tag makes it angle insensitive and also enhances the range of the tag. This is possible due to the presence of a battery and an independent frequency reference (the crystal or other frequency reference).
7. A coil or loop antenna attached to the CMOS radio modem that has been wound to achieve maximum signal strength. The coil may have a capacitor in series for optimal tuning.
8. Optional sensors for light, temperature, acceleration, humidity etc . . .
9. Optional LEDs to signal or indicate that one particular radio tag should be selected over another tag.
10. Optional display to display information linked to a product, such as the product ID number or expiry date, or lot number etc.
11. A reader or base station consisting of logic circuitry, a radio modem circuit, a and a loop antenna. The loop antenna may consist of medium gauge wire (10-12 gauge) with several turns of wire around the loop, and it can be placed on the perimeter around a room or a metal shelf for example, so the radio tags may be read and written to within that loop area. The distance the tag is read may be controlled by the size of the loop. For example the loop may be small, one foot by one foot, and a tag may be read or written to with that area and within several feet surrounding the area. Alternatively, the loop may cover a large area, 100×100 feet for example. In this case a radio tag may be read or written to anywhere within the 10000 sq foot area, as well as 20 to 30 feet beyond the loop's edge outside of the central area.
12. In public areas the same loop antennas may also be used as an Assisted Listening Systems (ALS) system. Similar loop antenna systems have been used to inductively broadcast analog audio signals within an area (U.S. Pat. No. 3,601,550, U.S. Pat. No. 3,426,151) and audio from store windows to hearing aids as disclosed in EP0594375A2. These antennas are widely used in Europe and Japan, with limited use in the US for ALS. These ALS systems most often that make use of t-coils placed in hearing aids. A “t-coil” is an inductive loop often with a ferrite core, optionally placed in a hearing aid that can pick up low-frequency audio signals in a room. The low frequency audio signal placed on the inductive loop is picked up directly by the t-coil and magnified by the hearing aid with little or no power penalty. In contrast to other radio antennas with signals that drop off with distance, these t-coil loop antennas offer at these frequencies a strong and relatively homogeneous magnetic field over a large area (up to 10,000 sq feet) with effective read/write distances of over 100 feet.

Noise considerations. For the LF frequencies used in the systems according to the invention, it is instructive to model noise sources and the rate at which noise falls off as a function of distance from the noise source. It is empirically seen that signal strength for some common noise sources is inversely proportional to the r squared for the LF frequencies used in the systems according to the invention. Thus noise signal strength at these frequencies drops off rapidly for a localized noise source—e.g. a ballast or switching transformer. It may be speculated that in some cases this rapid falloff is due to the noise source being more like a point source than like a source distributed along a line.

Meanwhile the area-read loop antennas used in an LF system according to the invention are often empirically found to have signal strengths that fall off more like inverse r than inverse r², giving the loop antenna an advantage as compared with the noise sources.

In contrast, for the higher frequencies of the prior art, for some noise sources the signal strength of the noise sources is empirically seen to fall off as the inverse of r (rather than r²) and therefore some noise sources have a much more global or long-distance effect.

Yet another factor which, perhaps non-intuitively, makes LF a good choice is a factor that is more a human-behavior factor than a laws-of-physics factor. The design decisions made by some system designers are design decisions in the direction of ever-higher frequencies. The mere fact that the FCC allows communication bands that are far higher in frequency, means that some designers seem compelled to use those higher frequencies. Thus empirical investigation reveals many locations, even open fields and parking lots, where the measured background noise is high for higher frequencies and low for lower frequencies.

It is also instructive to consider some of the standard rules of thumb for selection of radio frequencies for particular applications, and how those rules of thumb also make it somewhat counterintuitive to choose LF.

Again, as mentioned above, there are many noise source challenges to signals (e.g. all switching power supplies, machines, ballasts) that interfere at LF and not at higher frequencies. This would suggest using higher frequencies.

Also, in many RF noise models it is assumed that noise is proportional to 1/freq. On this assumption, it would seem that the way to reduce noise is to choose higher frequencies, and it would be counterintuitive to choose LF.

Finally, consider a definition of Quality Factor for a circuit at frequency f₁ in relation to a second frequency f₂, that is, Q, which is f₁/(f₁−f₂). To make Q high, it is desirable to make f₁−f₂ small. But at lower frequencies it is difficult to make f₁−f₂ small. Thus it is not easy to make Q high for low frequencies. This also makes it counterintuitive to choose LF.

So if a goal is to select a location for a tag system that turns out to have low noise, while it may seem counterintuitive when one considers other factors such as those discussed in the background section above, it may well be advantageous to choose low frequencies (rather than higher frequencies) for the operation of the tags.

So, LF has advantages that one might not appreciate at first blush.

Advantages flowing from the tags according to the invention include the following.

POC. POC (Point of Care) refers to the concept of using a mobile device at a point of care in a medical treatment location, such as a PDA in a hospital room, for recording or initiating transactions, medical information, time of treatment, or for billing purposes. Because the tags according to the invention are smart (having a battery and a time reference) they can keep track of the time and date upon which care is given.

No handheld reader needed. In most cases there is no need for a handheld reader. Instead, large “area read” antennas may be used and do not need to be nearly as close to a tag that is being read, as compared with other tag types.

EPC Global. The system is likely to be capable of being adapted to be compatible with formats used in the “EPC global” standard.

Tags of the type described here can be fashioned as wrist bands that offer “touchless” reads. The wrist band need not be particularly nearby to a reader as with prior-art tags.

Tags of the type described here can be used for dispensing medicines.

Tags of the type described here can offer human visibility for example through LEDs or LCD displays.

Tags of this type can be used to identify locations of objects. The objects each bear a tag and the tag is detected by one or more area read antennas.

These tags are usable with large area antennas and do not, like some prior-art tags, require directional antennas to do their jobs. Omnidirectional antennas can be used.

1. A method for use with a system comprising a plurality of radio tags and a host, the host comprising a radio receiver operating below 1 MHz and a radio transmitter operating below 1 MHz and an antenna coupled to the radio receiver of the host and to the radio transmitter of the host, each radio tag comprising a transmitter operating below 1 MHz and a receiver operating below 1 MHz, said each radio tag having a timing circuit and a battery, an antenna coupled to the radio receiver of the tag and to the radio transmitter of the tag, the method comprising the steps of:
operating the timing circuits of each of the plurality of radio tags, the timing circuits of the each of the plurality of tags running uncorrelated with the timing circuits of the other tags of the plurality of tags and at least sometimes uncorrelated with any timing circuit of the host;
broadcasting a first message from the host to the plurality of radio tags by means of the antenna coupled to the radio transmitter of the host;
successfully receiving at the host a response from a first one of the radio tags and not from the others of the radio tags, whereby the successful reception depends in part upon the uncorrelatedness of the timing circuits of the plurality of tags;
by the host, directing the first one of the radio tags to be silent;
broadcasting a second message from the host to the plurality of radio tags by means of the same antenna as the antenna employed to broadcast the first message;
successfully receiving at the host a response from a second one of the radio tags and not from the others of the radio tags, whereby the successful reception again depends in part upon the uncorrelatedness of the timing circuits of the plurality of tags;
by the host, directing the second one of the radio tags to be silent.

2. The method of claim 1 wherein the broadcasting, receiving, and directing stems are repeated until messages have been successfully received from at least five tags.

3. The method of claim 2 wherein the broadcasting, receiving, and directing stems are repeated until messages have been successfully received from at least ten tags.

4. The method of claim 1 wherein the operating of the timing circuits is carried out even in the absence of any transmitted RF energy from the host.

5. A system comprising a plurality of radio tags and a host, the host comprising:
a radio receiver operating below 1 MHz and a radio transmitter operating below 1 MHz and a loop antenna coupled to the radio receiver and to the radio transmitter,
each radio tag comprising a transmitter operating below 1 MHz and a receiver operating below 1 MHz, said each radio tag having a timing circuit and a battery,
the loop antenna exceeding one square foot in area;
each radio tag being communicatively coupled with the host by means of RF communications below 1 MHz.

6. The system of claim 5 wherein the loop antenna exceeds ten square feet in area.

7. The system of claim 6 wherein the loop antenna exceeds one hundred square feet in area.

8. The system of claim 7 wherein the loop antenna exceeds one thousand square feet in area.

9. The system of claim 8 wherein the loop antenna exceeds ten thousand square feet in area.

10. The system of claim 5 wherein at least one radio tag being communicatively coupled with the host is at least two feet outside of the loop.

11. The system of claim 10 wherein at least one radio tag being communicatively coupled with the host is at least ten feet outside of the loop.

12. The system of claim 5 wherein the number of radio tags in communicative coupling with the host exceeds ten.

13. The system of claim 12 wherein the number of radio tags in communicative coupling with the host exceeds fifty.

14. The system of claim 5 wherein each radio tag further comprises a DRAM or SRAM powered by the battery of the radio tag.

15. A method for use with a system comprising a plurality of radio tags and a host, the host comprising, a radio receiver operating below 1 MHz and a radio transmitter operating below 1 MHz and a loop antenna coupled to the radio receiver and to the radio transmitter; each radio tag comprising a transmitter operating below 1 MHz and a receiver operating below 1 MHz, said each radio tag having a timing circuit and a battery; the loop antenna exceeding one square foot in area; each radio tag being communicatively coupled with the host by means of RF communications below 1 MHz, the method comprising the steps of:
operating the timing circuits of each of the plurality of radio tags, the timing circuits of the each of the plurality of tags running uncorrelated with the timing circuits of the others of the plurality of tags and at least sometimes uncorrelated with any timing circuit of the host;
broadcasting a first message from the host to the plurality of radio tags by means of the loop antenna coupled to the radio transmitter of the host;
successfully receiving at the host a response from a first one of the radio tags and not from the others of the radio tags, whereby the successful reception depends in part upon the uncorrelatedness of the timing circuits of the plurality of tags;
by the host, directing the first one of the radio tags to be silent;
broadcasting a second message from the host to the plurality of radio tags by means of the same loop antenna as the loop antenna employed to broadcast the first message;
successfully receiving at the host a response from a second one of the radio tags and not from the others of the radio tags, whereby the successful reception again depends in part upon the uncorrelatedness of the timing circuits of the plurality of tags;
by the host, directing the second one of the radio tags to be silent.

16. The method of claim 15 wherein the broadcasting, receiving, and directing stems are repeated until messages have been successfully received from at least five tags.

17. The method of claim 16 wherein the broadcasting, receiving, and directing stems are repeated until messages have been successfully received from at least ten tags.

18. The method of claim 15 in which the operating the timing circuits of each of the plurality of radio tags is at least sometimes carried out in the absence of any transmitted RF energy from the host.

19. A system comprising a plurality of radio tags and a host, the host comprising:
a radio receiver operating below 1 MHz and a radio transmitter operating below 1 MHz and a antenna coupled to the radio receiver and to the radio transmitter,
each radio tag comprising a transmitter operating below 1 MHz and a receiver operating below 1 MHz, said each radio tag having a timing circuit and a battery, each radio tag disposed to receive RF communications while powered by the battery in the absence of RF energy emitted by the radio transmitter of the host,
each radio tag being communicatively coupled with the host by means of RF communications below 1 MHz.

20. A radio tag comprising:
a transmitter operating below 1 MHz and
a receiver operating below 1 MHz,
said each radio tag having a timing circuit and a battery, the radio tag disposed to receive RF communications while powered by the battery even in the absence of RF energy received from external to the tag;
the radio tag disposed to receive a command from external to the tag, to be silent for an interval of time measured by the timing circuit;
the radio tag affixed to a movable object rather than to a stationary object.

21. A system comprising a plurality of radio tags and a host, the host comprising:
a radio receiver operating below 1 MHz and a radio transmitter operating below 1 MHz and a loop antenna coupled to the radio receiver and to the radio transmitter,
each radio tag comprising a transmitter operating below 1 MHz and a receiver operating below 1 MHz, said each radio tag having a timing circuit and a battery, each radio tag disposed to receive RF communications while powered by the battery even in the absence of RF energy emitted by the radio transmitter of the host,
each radio tag being communicatively coupled with the host by means of RF communications below 1 MHz;
the loop antenna having an area and a perimeter, the perimeter defining concavities reducing the area of the antenna by at least ten percent.
